(19) United States
(12) Patent Application Publication
(10) Pub. No.: US 2020/0039594 A1
(43) Pub. Date: Feb. 6, 2020

(54) PERIPHERAL GROUND PROJECTED SIGNAL ILLUMINATION FOR VEHICLE

(71) Applicant: Daniel Ebrahemi, Sonoma, CA (US)

(72) Inventor: Daniel Ebrahemi, Sonoma, CA (US)

(21) Appl. No.: 16/653,481

(22) Filed: Oct. 15, 2019

Related U.S. Application Data
(63) Continuation-in-part of application No. 16/505,336, filed on Jul. 8, 2019.
Application No. 16/505,336 is a continuation of application No. 16/101,218, filed on Aug. 10, 2018, now Pat. No. 10,392,068.
(60) Provisional application No. 62/634,708, filed on Feb. 23, 2018.
(60) Provisional application No. 62/605,762, filed on Aug. 25, 2017.

(51) Int. Cl. B62J 6/02; B62K 19/40; B62K 21/12; B62J 6/00

(52) U.S. Cl. CPC B62J 6/02; B62K 19/40; B62J 2006/006; B62J 6/005; B62K 21/12

(57) ABSTRACT

A vehicle including a light projector, said light projector having a light source disposed to project light through a lens and a removeable imager; a controller coupled to the light projector and operable to receive a user control and direct the light projector to operate the light source; a user control, said user control coupled to the controller, and a rotation sensor coupled to the user control and operable to sense movement of a vehicle steering mechanism, said rotation sensor coupled to the controller, wherein the controller operates the light projector in response to the rotation sensor.

### PRIORITY

This application is a continuation-in-part of co-pending application Ser. No. 16/505,336 filed Jul. 8, 2019 which claims the benefit of co-pending application Ser. No. 16/101,218 filed Aug. 10, 2018 which further claims the benefit of provisional patent applications 62/634,708 (filed Feb. 23, 2018) and 62605762 (filed Aug. 25, 2018), all three of which are incorporated by reference as if fully set forth herein.

### TECHNICAL FIELD

This patent involves Bicycle electronic lights and bicycle handlebars, in the field of transportation and recreation.

### BACKGROUND

Bike lights are both useful at night and daytime to allow the rider to be visible and thus increase their safety and lower their risk of injury.

### SUMMARY

Disclosed herein is vehicle with a light projector, said light projector having a light source disposed to project light through a lens and a removeable imager; a controller coupled to the light projector and operable to receive a user control and direct the light projector to operate the light source; a user control, said user control coupled to the controller, and a rotation sensor coupled to the user control and operable to sense movement of a vehicle steering mechanism, said rotation sensor coupled to the controller, wherein the controller operates the light projector in response to the rotation sensor.

Various embodiments may provide for illuminating both the direction of impending travel and the direction of current travel, so that the light projector may project a light image in different areas. Some embodiments may detection of on-coming light to change the projected light.

### BRIEF DESCRIPTION OF DRAWINGS

FIG. 1 shows a representative example of a system according to the present disclosure

FIG. 2 shows a view of a handlebar assembly according to an embodiment of the current disclosure.

FIG. 3. shows an example bar assembly.

FIG. 4 shows the main components of the light projector.

FIG. 5. shows an exploded view of an embodiment of a bar assembly.

FIG. 6. shows a functional block diagram of parts of a system in accordance with this disclosure.

FIG. 7 shows a lighting projection system mounted on a bicycle.

FIG. 8 shows a break-way drawing of one embodiment of a lighting projection system.

FIG. 9 shows a light projector with removeable imager.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example, and without limitation, in cases in which a measure or value is “relatively increased” or “relatively more”, that comparison need not be with respect to any known measure or value but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

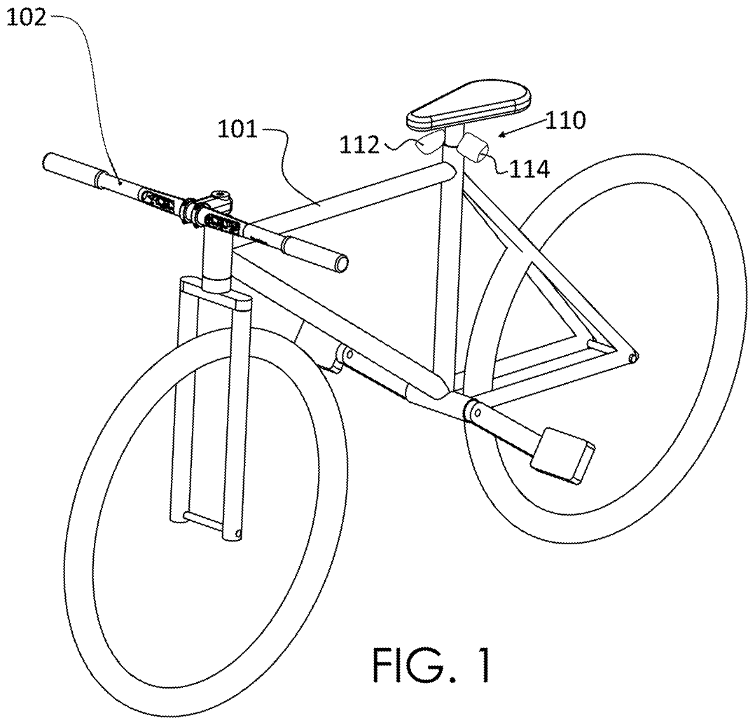

FIG. 1 shows a representative example of a system according to the present disclosure. The system includes of a handlebar assembly 102 installed on the bicycle 101. Attached to the bicycle seat post is an adjustable-position light projector assembly 110 with two light projection tubes 112 and 114.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effectuate such feature, structure or characteristic in connection with other embodiments whether or not explicitly described. Parts of the description are presented using terminology commonly employed by those of ordinary skill in the art to convey the substance of their work to others of ordinary skill in the art.

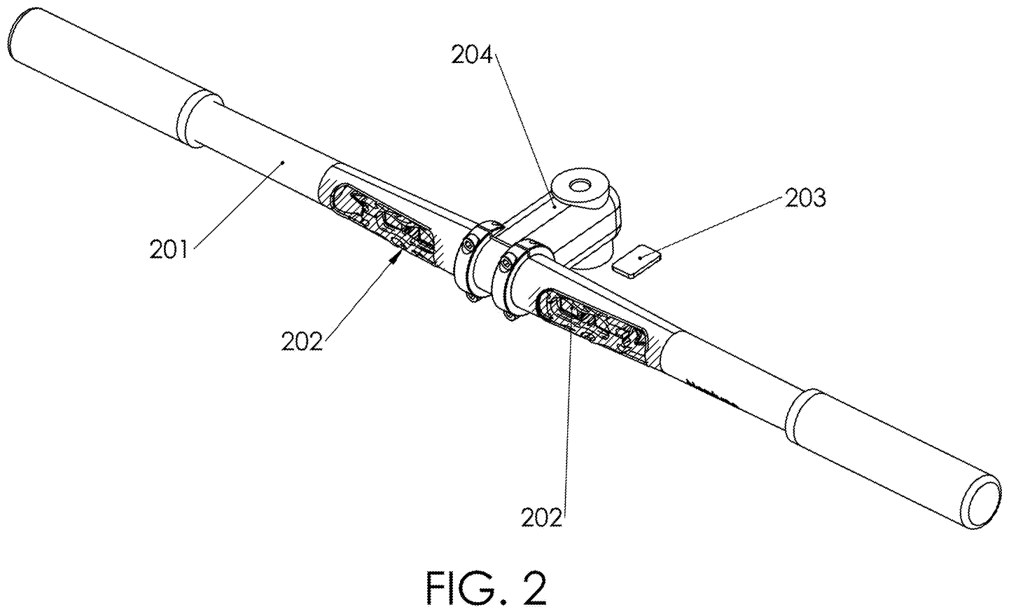

FIG. 2 shows a view of a handlebar assembly according to an embodiment of the current disclosure. The handlebar 201 is the main support structure for some of the system components. The handlebar assembly may be assembled with a split at the center or detachment anywhere along length of bar in order to permit access to insert the internal components during manufacturing. The bar 201 may be made with a variety of materials, but not limited to, aluminum, steel, stainless steel, metal, wood, carbon fiber, or plastic and any combination of those. The bars 201 can be treated, but not limited to, painted, anodized, electro-plated, sandblasted, bead-blasted, or any combination thereof. This embodiment can house two light assemblies 202 in the bar 201, for example on the left and right sides. The light sources are contained inside the bar or in cavities in the bar in order to reduce the protrusion of the lights, giving a smaller envelope size and reducing aerodynamic drag during use. The light source may be incandescent, light emitting diodes (LEDs), halogen, fluorescent, or other suitable form to provide lights. Alternatively, or additionally, the system could have alternative lights pointed to side or angled away from the main focus beam of the primary lights. There can be one light each for left and right sides, or a multiple array of lights for each left/right side.

The stem 204 clamps the handlebar 201 in a rigid fashion. In one example a rotation sensor 203 is mounted on the bicycle frame. The sensor can be used for measuring the twist angle of the handlebar.

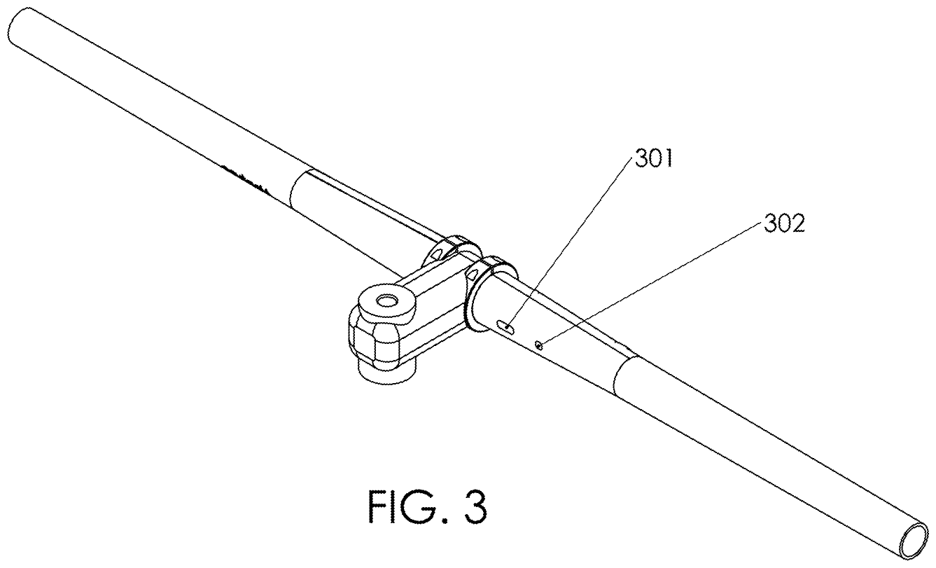

FIG. 3 shows an example back view of a handlebar according to some embodiments. There can be a charge connector 301. The unit's battery may be charged through a charge port 301 which may be USB, DC, or AC adaptable, and has a protective cover. The unit may be waterproofed to shield the handlebar unit from outdoor use, rain, and water. Waterproofing includes the parts around the light windows, the charge port 301, a button port 302, and any interfaces between assembled parts of the handlebar.

The user button 302 on the bars allows the user to turn the system on and off, and change light modes, and other functionality. One or more elements of the handlebar, buttons, ports, and the like, provide for user control of certain operations. Some embodiments may also employ a light sensor (not shown) for detecting remote light sources.

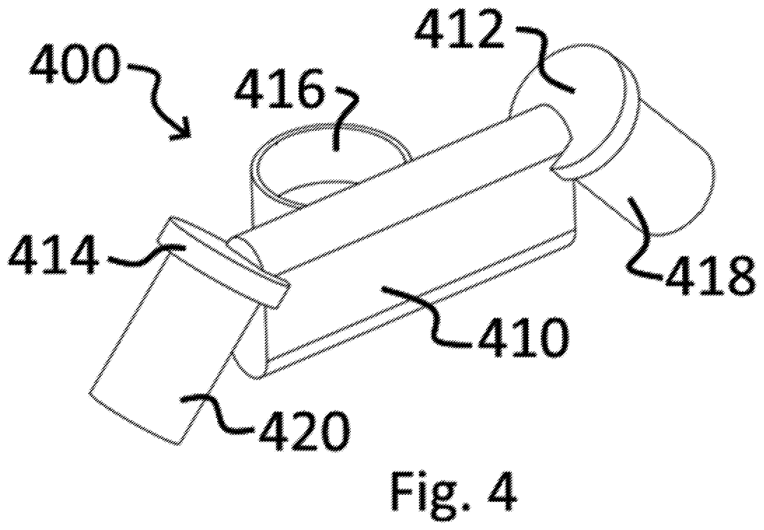

FIG. 4 shows the main components of the light projector assembly 400. The enclosure body 410 includes control electronics and power supply for operating light sources 412 and 414. The light source may include lensing 418 and 420 to shape and help project light from light sources 412 and 414 respectively. The light sources 412 and 414 and lensing is swivelly mounted to the enclosure body 410 to allow for positioning the light sources 412 and 414. The enclosure body 410 is connected to a mounting clamp 416 for mounting the entire assembly to a vehicle such as a bicycle. As shown in FIG. 4 the light projector assembly 400 may be mounted using a circular clamp for fitting on a seat post of a bicycle.

The control electronics may be a commercially available controller which includes memory for providing program instructions and input/output circuits such as Bluetooth, Wifi and the like. Moreover, the controller may independently operate multiple lights (not shown) in each light source. Light source operation may be effectuated by driver circuits (not shown) coupled between the controller and the light sources. In operation the controller may receive a wireless (or wired) command instructing it to illuminate a red light. The red light may be any commercial light such as an LED or laser light source. Other colors and types of lights may also be controlled in this manner, such that in certain embodiments, the signal may command operation of a white light, or a combination of different lights.

The lights 412 and 414 illuminate through lensing 418 and 420 which acts to shape the illumination of the light beam. For example, and without limitation, the lensing may form an arrow, which may then be projected down towards the ground. Other images may be projected such as company logos, cartoons and the like.

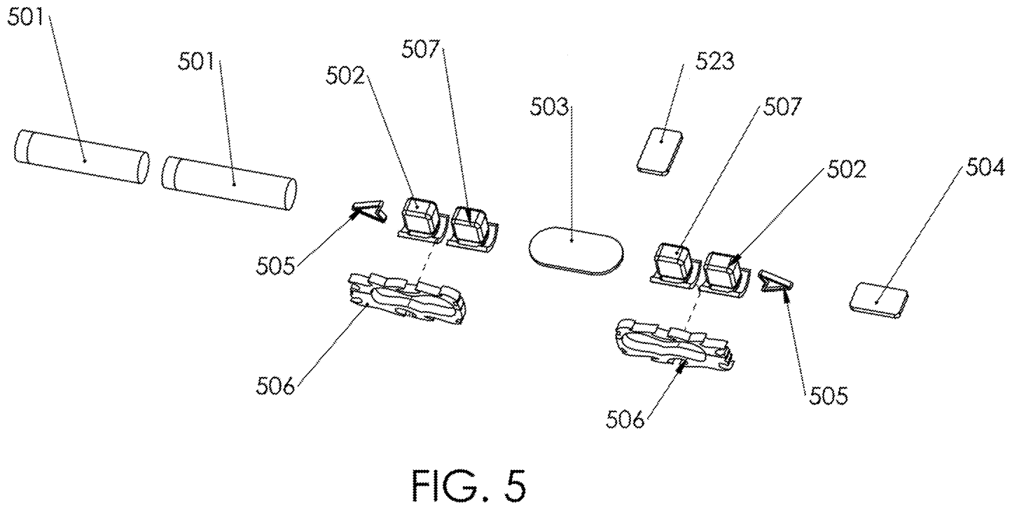

FIG. 5 shows example internal parts of the handlebar assembly. The batteries 501 can be rechargeable such as lithium iron phosphate, lithium ion, lithium metal, lead acid, nickel metal hydride, or non rechargeable such as alkaline. The batteries can be any combination of series and parallel from one to ten batteries in the module.

The Light Modules 507 and secondary lights 502 contains a light source, motor, heat sink, and mounts for the left and right sides. The lights 507 and 502 may be LED, incandescent, halogen, xenon, and the like. The lights are in contact with a thermal heat-sink to dissipate the local heat generated from the lights. The heat-sinks can be made of metal such as steel or aluminum or ceramic material. The heat-sink could also be water cooled in other embodiments. Each light module is mounted onto a turning motor which could be a for example stepper, micro stepper, servo, DC motor, or actuator. The turn signal light 505 is a light indicator for signaling left and right turns for the user. On the front facing screen/light module of our actual product there can be an arrow for Left and Right turn signals that are unlit during normal riding and that can only be activated to flash either left or right when the rider is riding for example, and taps a section of the brake lever (or use a small button), or a push sort of button/sensor on the handle part of the bar pointing down so that it is not noticeable yet easy for riders to access when riding and wanting to turn right or left. When users “activate” turn signal the arrow will flash either white, blue, red, green, (can be any color of the rainbow essentially) etc in the direction that they choose to hit the button (right or left), so that oncoming riders, pedestrians, cars, motorcycles will know that a bike is coming. In addition, while this lighted arrow is lighted and doing its job, our original invention idea of the lights turning with the handlebar will also be working in sync with the signal arrow, adjusting up and down/left to right.

In one exemplary embodiment, there can be two light shapes in each side of the handle bar (left and right sides of the bar), where one of the lights can turn left and right movement and where one of the smaller lights for example can act as a guide to keep looking straight ahead and somewhat down so riders can see the road floor underneath for rider safety.

The accent light 506 can be always on or turn off at certain times. It has a plastic light-pipe to disperse the light and act as visual interest to the product. There are many shapes and styles of the accent light 506 possible.

The component parts will be adequately life tested to make sure that they will not fall apart, break/deteriorate, fog, fail etc. even after five years of use for example. The internal electronics and components should be well supported and reinforced to the inner upper and lower edge of the handlebar inside, and not come loose or rattle during operation.

An example control circuit board 503 (“PCB”) controls the signal which actuates the lights and manages power to the battery. The control circuit board may include a microcontroller, a processor, or similar circuitry. The control circuit may be formed using a commercially available controller which includes I/O functionality and wireless communications such as Bluetooth and Wi-Fi. A turn angle sensor (or rotation sensor) 523 may be mounted on the frame outside of the handlebar 201. Alternatively, a turn angle sensor 504 may be mounted inside of the bar 201 to measure relative turn angle. The twist sensors 523 could be inside the bar or attached to the handlebar 201 or bicycle frame 102 and connected to the PCB board with wires. The sensors measure relative rotation twist of handlebars and allow the system to act in response to the handlebar twist. The sensor could be a pair of accelerometer/gyros, inertial measurement unit (IMU), or potentiometers or rotary encoder, and the like to measure angle twist of the steering mechanism relative to the frame. The sensor may measure angle relative to the frame by containing a fixed part mounted to the frame which defines a center or a home position of the steering mechanism twist angle.

In another embodiment there can be an option to include a solar cell or panel so in case a user forgets to charge the USB and is riding at night the system will have sufficient power. If the battery dies, solar panel or cell provides power to system. Also, the sensor picks up the night style riding and automatically turns on when the environment gets dark. Also, the system should turn on with small switches and have different mode settings and color changes if a rider wants.

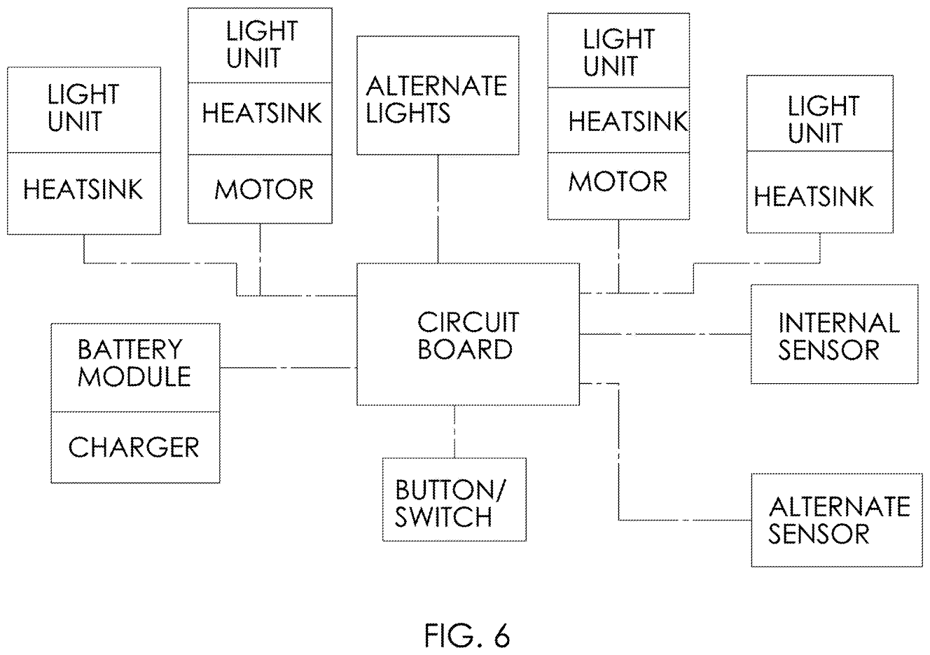

FIG. 6 shows an example electronic circuit diagram for the system disclosed herein. The circuit board takes inputs from the Internal and Alternate sensors, performs an algorithm with embedded software, and outputs signals to the light motors and light modules (primary, secondary, and accent lights). Power from the batteries 501 supports the system for the user to operate the product. The charger supplies energy to the battery module. A button or switch can turn the system on/off and also change light modes. Many software algorithms are possible. In one embodiment the light will adjust to high beam/high intensity mode when there is no oncoming traffic or biker/motorcycle or any other kind of light from the opposite side of traffic, and as soon as the sensor detects that then the lights adjust to normal low beam intensity for example.

In another embodiment, alternate sensors may include a microphone for voice recognition features taking user voice commands as inputs and output behavior of the light modules including motion and brightness settings. In some embodiments, a programmable controller could reference common voice commands from local storage of voice characteristics. Voice commands may allow for changing to high beams, or for turn signal actuation.

In another embodiment, the software can have a road condition setting for example, “rock/trail terrain” so that it automatically senses the riders riding pattern using software and hardware and adjusts the light mode and stiffness of the up/down movement and left/right movement with the road conditions of the biker. In other words, the system detects, using on-board sensors such as accelerometers, the riding pattern/behavior and adjusts the output accordingly with hardware and software according to programmed routines, such as dampening an input from a rotation sensor.

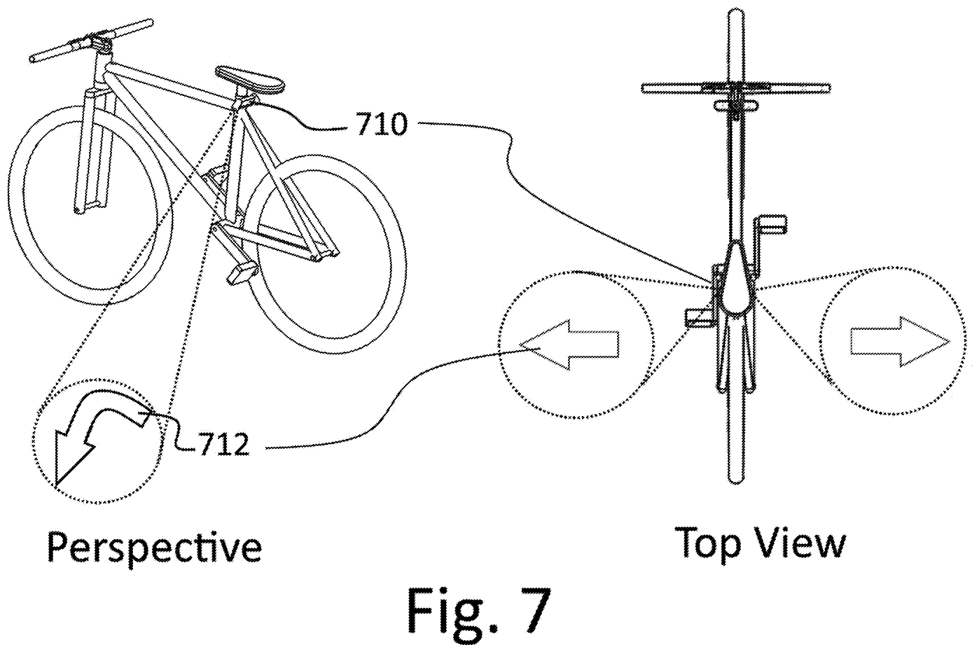

FIG. 7 shows a light projector mounted on a bicycle. In FIG. 7 a light projector 710 is mounted to a seat post of a bicycle. The projection system 710 includes a light source and lensing 712 positioned to project a light image 712 onto the ground surface away from the bicycle. The projection system may be battery operated and operable to receive control signals from another wirelessly connected device such as an app of bicycle-mounted user control. Some embodiments may include hard-wired connections to user controls mounter elsewhere on the bicycle such as handlebars. The light projector 710 may be configured to have multiple colored light sources and to project different shaped optical images.

In operation, a user sends a control signal to the light projector 710 directing the light projector to illuminate certain effects. For example, and without limitation, the user signal may direct the light projector 710 to illuminate the left-side surface with an arrow to effectuate a turn signal. Some embodiments may direct the light projector 710 to product simultaneous images to create a custom affect.

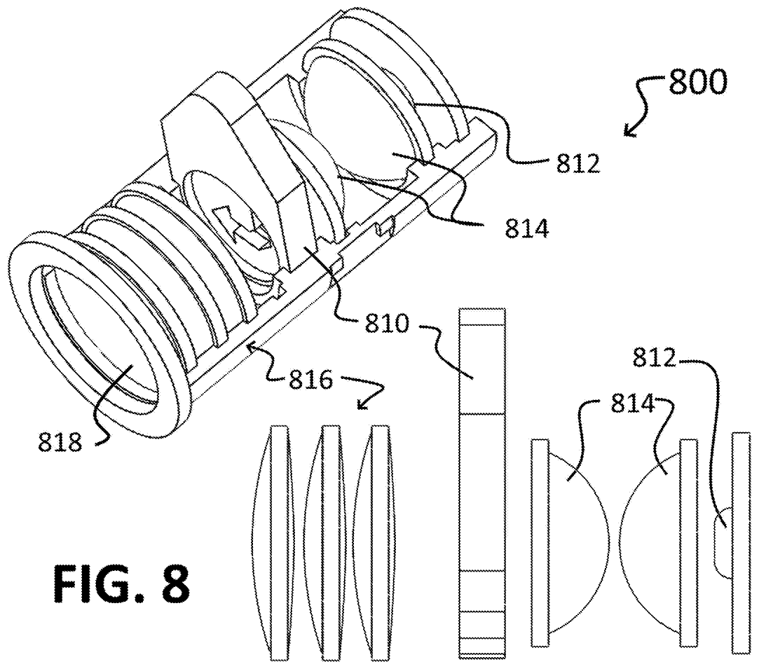

FIG. 8 shows a break-way drawing of one embodiment of a lighting projection system 800. In FIG. 8 a lighting imager 810 is inside a projection case. The imager is a frame with an internal structure design to shape a beam of light by allowing a certain pattern to pass through while blocking unwanted light. In FIG. 8 the light beam would be shaped to form an arrow. A light source 812 is also placed in the projection case, positioned to splay light towards the imager 810 through magnifying lenses 814. The lens 814 operate to focus and shape the light beam before it enters the imager 810. As the light leaves the imager 810 it passes through a second set of lenses 816 to re-focus the projected image as it leaves the device through window 818.

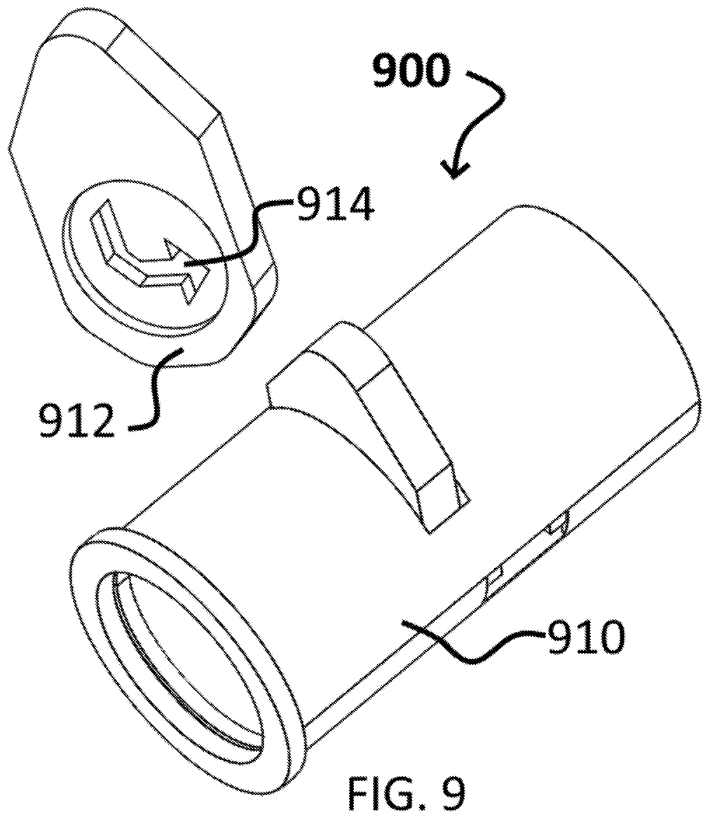

FIG. 9 shows a light projector with removeable imager 900. In FIG. 9 a light projector as described herein is placed inside a tube or container 910. The container include a slot that opens into the light path of the projector, A removeable imager 912 may be placed through the slot thus providing for the imager to shape a beam of light inside the projector.

The imager 912 include a shape template 914 which is used to govern the shaping of the beam in the projector 900. In operation, a user may change the imager 912 with ones having different shapes thus effectuating a different beam of light from the projector 900.

The structure and techniques of present disclosure may, in some embodiments, include lights installed in pedals, seat back, and on the rear frame (in the “rear triangle” portion) of a bicycle.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed:

1. A vehicle including:
a light projector, said light projector having a light source, said light source disposed to project light through a window;
a controller coupled to the light projector and operable to receive a user control and direct the light projector to operate one or more of the light sources;
a user control, said user control coupled to the controller, and
a rotation sensor coupled to the user control and operable to sense movement of a vehicle steering mechanism, said rotation sensor coupled to the controller,
wherein the controller operates the light projector in response to the rotation sensor.

2. The vehicle of claim 1 wherein the light projector further includes a removable imager, said imager configured to shape a light beam emitted from the light projector.

3. The vehicle of claim 2 wherein the imager is disposed between a magnifier and a lens wherein light from the light source passes through the magnifier, imager, and the lens.

3. The vehicle of claim 1 further wherein the light projector includes a magnifier and a lens disposed to substantially direct the light through the window.

4. The vehicle of claim 1 wherein the light projector is adjustably mounted on the vehicle.

5. A method of lighting including:
disposing a light projector on a vehicle;
disposing a steering position sensor on the vehicle;
coupling the steering sensor and the light projector to a controller, wherein the controller operates the light projector in response to information from the sensor.

6. The method of claim 5 wherein the light projector is adjustably mounted on the vehicle such that light is projected onto the surface around the vehicle.

7. The method of claim 5 wherein the light projector further includes a removable imager, said imager configured to shape a light beam emitted from the light projector.

8. The method of claim 5 wherein the imager is disposed between a magnifier and a lens wherein light from the light source passes through the magnifier, imager, and the lens.
